(19) United States
(12) Patent Application Publication
(10) Pub. No.: US 2016/0113446 A1
(43) Pub. Date: Apr. 28, 2016

(54) SPILL-RESISTANT CONTAINER

(71) Applicants: STEPHEN BAROOK, Richmond Hill (CA); SAUL RAJSKY, Richmond Hill (CA)

(72) Inventors: STEPHEN BAROOK, Richmond Hill (CA); SAUL RAJSKY, Richmond Hill (CA)

(21) Appl. No.: 14/520,657

(22) Filed: Oct. 22, 2014

(51) Int. Cl. A47J 47/02; B65D 45/32; B65D 51/24; B65D 43/02

(52) U.S. Cl. CPC A47J 47/02; B65D 43/0231; B65D 43/0214; B65D 45/325; B65D 51/242; B65D 51/248

(57) ABSTRACT

A spill-resistant container, that both permits easy access to solid items, and retains these items within, even when dropped, tipped, or shaken. Said spill-resistant container comprises of a means for cleaning or replacing the lid of the container, a means to detect a hand movement of a user inside of said container and a means to stably keep the container in a slippery surface.

### FIELD OF THE INVENTION

The present invention is directed to a spill-resistant container, specifically a spill-resistant container that both permits easy access to solid items, and retains these items within, even when dropped, tipped, or shaken.

### BACKGROUND OF THE INVENTION

When providing a food storage device for a child such factors as the ability to contain and clean messes, providing a secure handle, and encouraging the child to eat are important. There exist many types of containers that serve to store food contents that are aimed at children. The prior art describes containers with snap lids, and screw tops lids. Many of these food containers do not describe an adequate handle which may make it difficult for children to hold on to the container. Containers with the above described lids allow for the possibility that the food contents are spilled when the lids is open or simply not close adequately.

Most food containers that are capable of being spill proof also do not have a means for cleaning or replacing the lid. At times when the lid is damaged or cannot be cleaned adequately a user will have to purchase a completely new container instead of only replacing the lid.

The prior art does not describe devices that encourage a child to reach into a container and remove its contents thereby possibly encouraging the child to eat. The present invention is capable of playing a chime, song, animal sound or similar whenever the child reaches in the container.

The present invention provides a spill-proof container that is easy and secure for a child to handle. It allows for easy replacement of its constituent parts and can serve to encourage a child to eat snacks that are placed in it.

### SUMMARY OF THE INVENTION

A food container assembly comprising a cylindrical shaped base for storing dry food objects having a bottom end being enclosed and a top end being open; said cylindrical shaped base having an interior and an exterior surfaces; a first annular ring having a first end and a second end, wherein said first end being attached to said top end of said base by a coupling means and said second end being attached to a cover; said cover extending across said first end, wherein said cover comprising of two overlapping semicircular sections of a fabric, said cover being attached to said first annular ring by an attaching means; a second annular ring being attached to said first annular ring having a wall, said wall having a height and a width; a penannular shaped handle being extended from said wall; and a motion sensor to detect a hand movement of a user inside of said base being attached at said interior surface of said base.

The present invention is a spill resistant container that is ideally suited for children or anyone wishing to prevent the spilling of food contents from a container.

The present invention has an opening that is sized to fit a user's hand when a user reaches in to retrieve the food contents in the container. The cover of the container contains an opening which automatically opens by the force of the user's hand as it enters and closes as the user's hand exits the interior of the container.

The cover is of the container is housed on an annular ring located at the top of the container. The annular ring is removable to allow for easy cleaning of the cover and the handle. For this purpose the present invention contains a handle attached to an annular ring which allows for easy holding and adjusting the position of the food container. The annular ring can be removed and be cleaned separately from the food container if a user wishes.

A primary objective of the present invention is to provide a food container with a convenient holding means.

A secondary objective of the present invention is to provide a means of holding food without spilling it by providing an easily retractable covering means.

A third objective of the present invention is to encourage children to use the device which is accomplished by a chime or sound playing when a child insert his or her hand inside the container.

A fourth objective of the present invention is to provide a more secure placement of the device when it is placed on surface. The present invention uses non-slip materials at the bottom of the base in order to increase the coefficient of friction between the base and the surface on which the present invention is placed.

A fifth objective of the present invention is to provide a transparent covering means so the children can see through the container from the above and this feature encourage children to use the device and put their hand inside an opening.

A sixth objective of the present invention is to provide a means for easily replacing the spill proof lid without requiring the purchase of replacement of the entire container. The present invention is capable of being dismantled into its components and gives a user the ability to replace the cover fabric that serves to make the present invention spill proof.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a side view of the present invention with its component parts;

FIG. 2 shows an isometric view of the present invention;

FIG. 3 shows a user using the present invention;

FIG. 4 shows an alternative embodiment of the present invention having a motion sensor;

FIG. 5 shows another alternative embodiment of the present invention having a transparent cover; and

FIG. 6 shows a third alternative embodiment of the present invention having slip resistant bottom surface; and

FIG. 7 shows an alternative embodiment of the present invention having replaceable covering fabric.

### DETAILED DESCRIPTION OF THE DRAWINGS

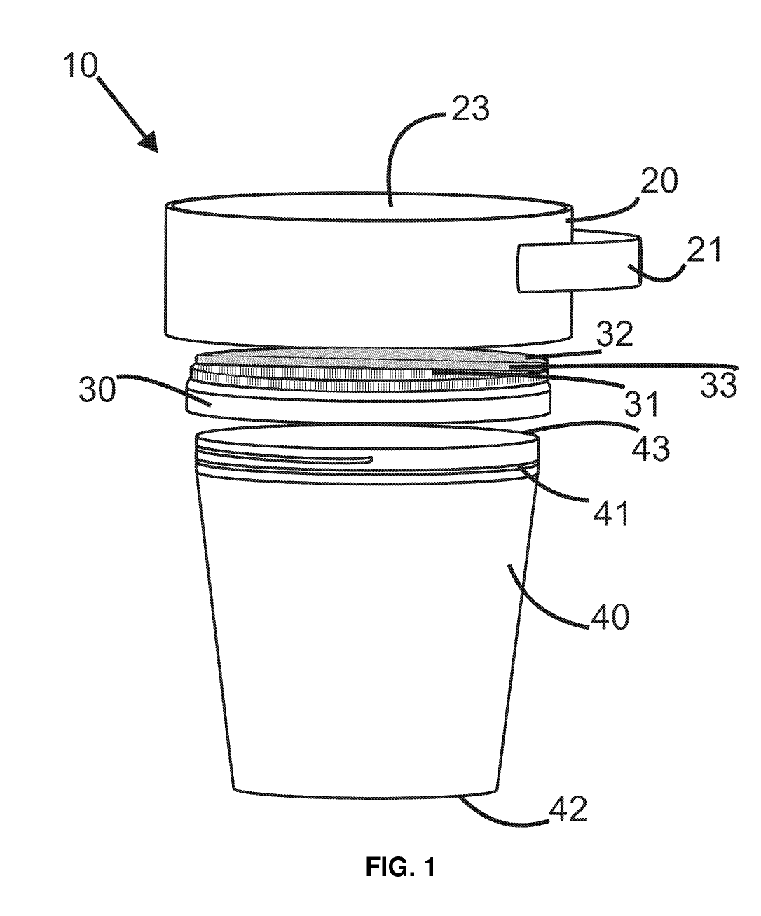

FIG. 1 shows the preferred embodiment of the present invention. The present invention 10 is a food container composed of three separate parts. A base 40, a first annular ring 30, and a second annular ring 20. The present invention can be disassembled for easy cleaning and access to interior of each part. The base 40 serves to store food contents and is of a cylindrical shape. The bottom 42 of the base 40 is of smaller diameter than the top 43 in the preferred embodiment. The first annular ring 30 is capable of being fastened onto to the base 40 by the presence of a screw thread 41 at the top 43 of the base 40. The first annular ring 30 houses a cover 31-32 which automatically opens by the force of the user's hand as it enters and closes as the user's hand exits the interior of the container.

The first annular ring 30 is also detachable from the second annular ring 20. The second annular ring 20 contains a screw thread 22 on its interior side 23 that serves to secure the first annular ring 30. Providing such a means for removing the first annular ring 30 from the top allows for easier replacement of the first annular ring 30 in case the fabric 31-32 loses elasticity or is damaged.

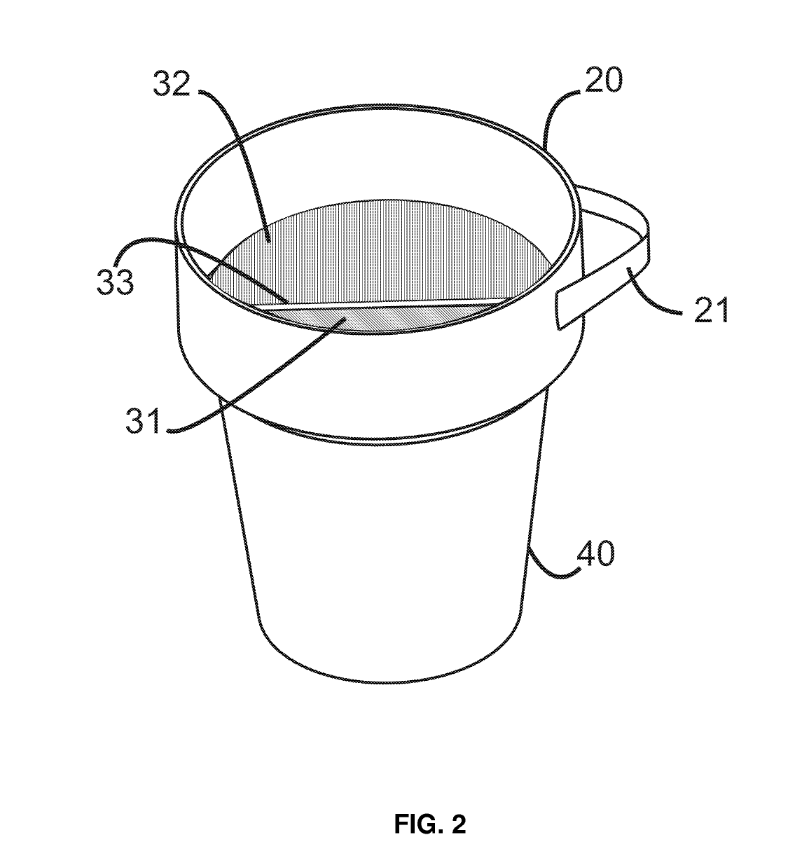

As shown in FIG. 1 and in an isometric view in FIG. 2, the cover fabric 31-32 can be made of two pieces an elasticized fabric that overlap in the middle of the first annular ring 30. Thus, there exists a means by an opening 33 located between the two covers 31-32 for accessing the interior of the base 40.

Again referring to FIGS. 1 and 2, the second annular ring 20 of the present invention 10 is annular ring that is mounted detachably to the base 40 and cover 30. The second annular ring 20 contains a handle 21 that is attached to its side. The handle 21 provides a means for securely holding and adjusting the position of the present invention. The handle 21 extends sufficiently enough and is of a sufficient volume to provide a secure means of holding for an infant or small child.

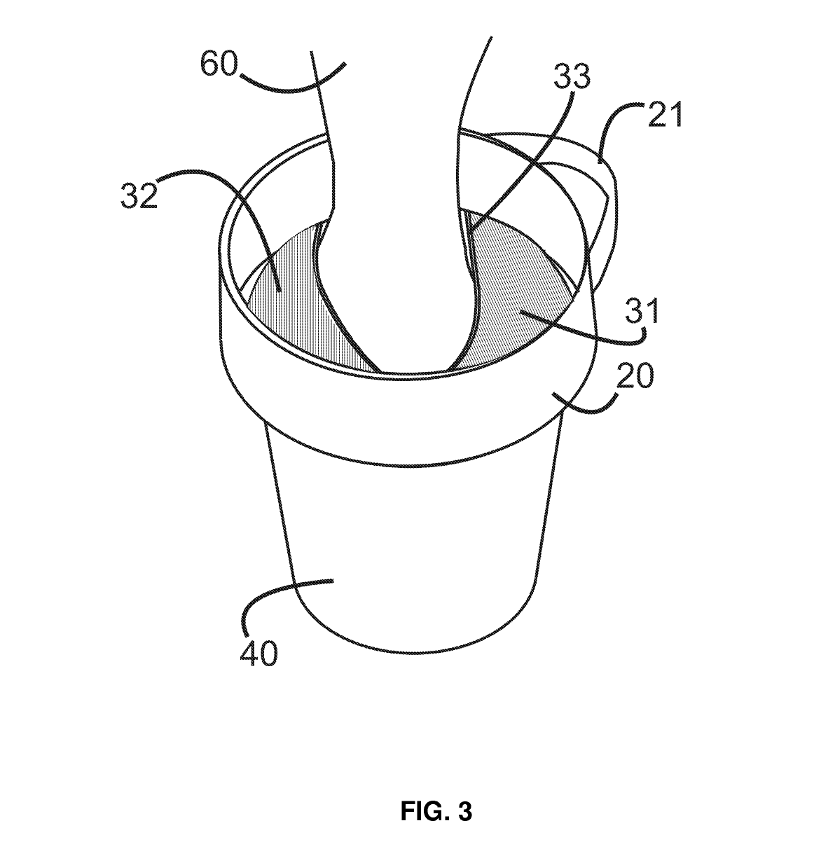

FIG. 3 shows the present invention 10 in use by a user. As a user inserts their hand 60 through the opening 33, the covers 31-32 are pushed aside and allow for a user's hand 60 to access the contents that are located at the base 40 of the present invention. Upon removal of a user's hand 60 the covers 31-32 fall back in place to cover opening 33.

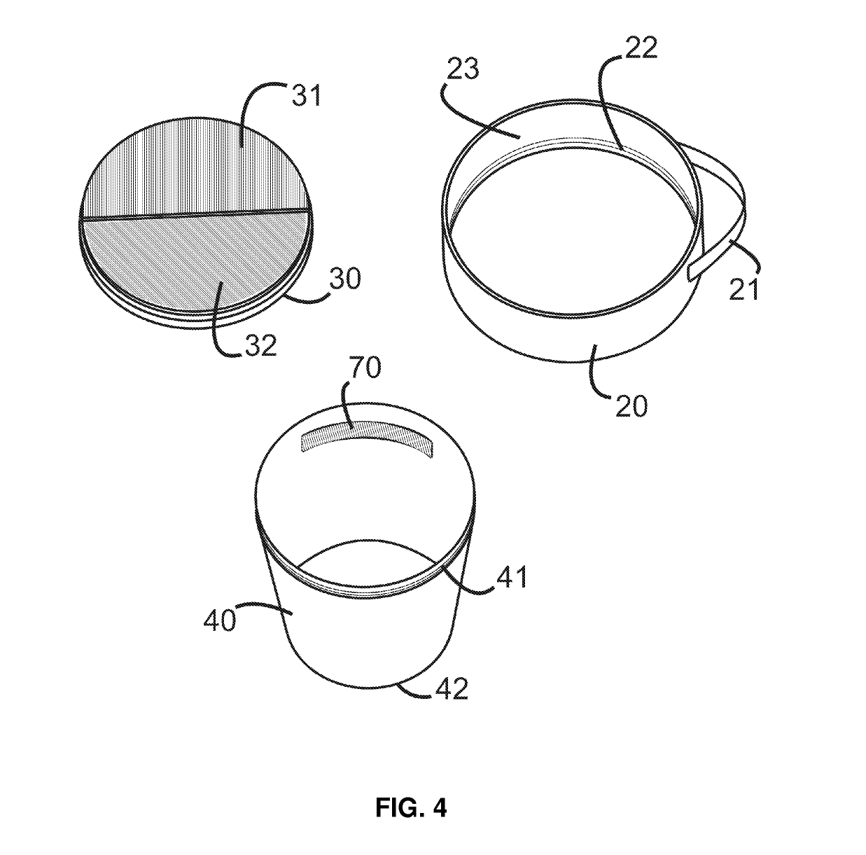

In FIG. 4 an alternative embodiment of the present invention is shown. A sensor 70 is located near the top 43 of the base 40. The sensor 70 may be powered by small battery such as a watch battery that can be placed at the bottom 42 of the base 40. The electronic circuitry of the sensor 70 is enclosed in a waterproof container thus making this embodiment of the present invention 10 dishwasher safe. The sensor 70 is capable of detecting movement. As such, when a user's hand 60 passes by the sensor 70 it can trigger an animal noise, a musical tone, or other type of sound to encourage a child from reaching in and removing food from the base 40.

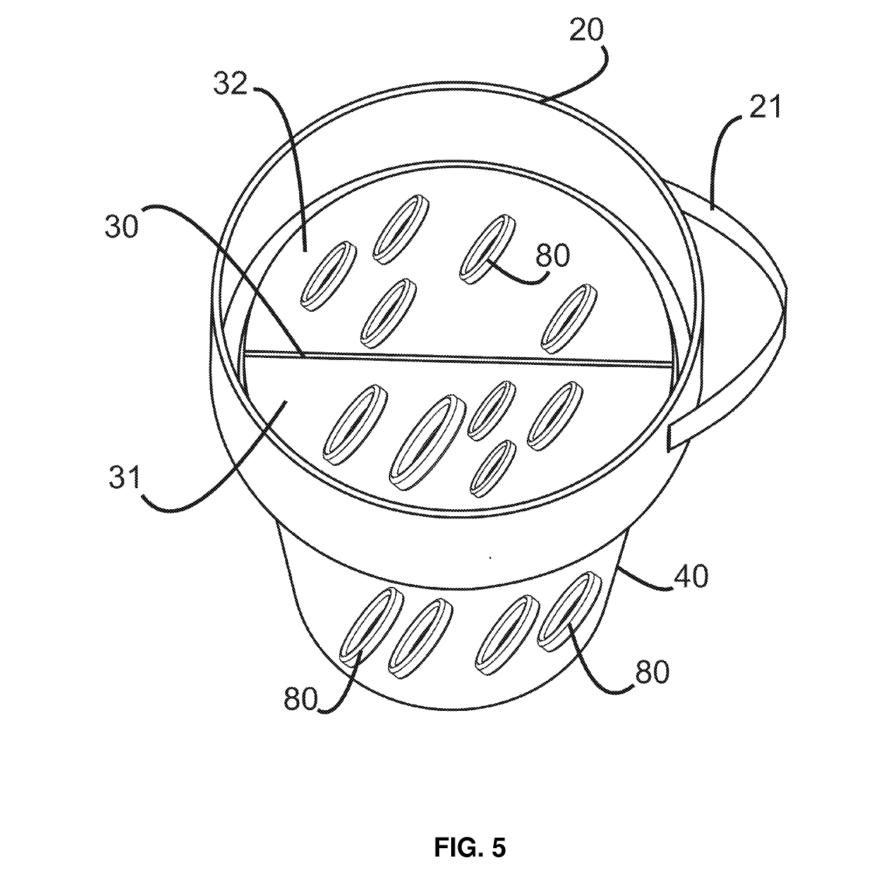

Another alternative embodiment is shown in FIG. 5. In this embodiment the covers 31-32 are transparent. The covers 31-32 are, as in the previous embodiments, composed of elasticized materials such as a clear rubber and a resilient fabric. The covers 31-32 in this embodiment allow for a user to easily view the food contents 80 that are placed inside the base. This embodiment does not require a user to lift or tilt the present invention 10 in order to view the contents 80. Additionally, it allows for opaque bases 40 to be used with the present invention 10 while still allowing for a user to view the amount of food contents 80 that are remaining.

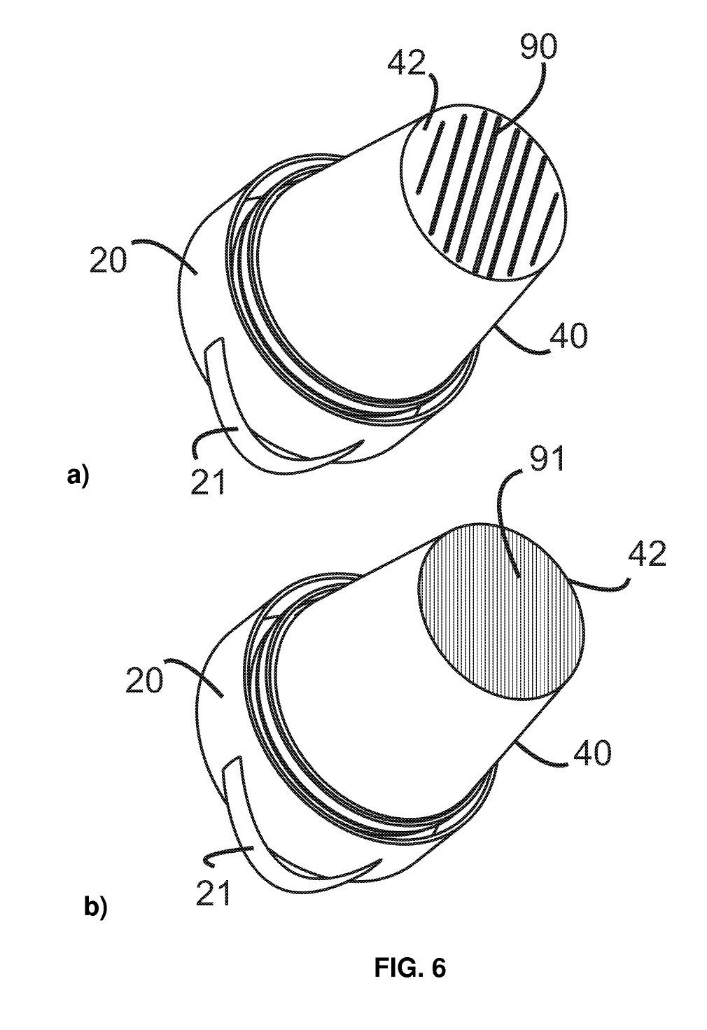

FIG. 6 (a-b) shows an embodiment of present invention 10 with a modification intended to add stability and prevent slipping. At the bottom 42 of the base 40, strips 90 of a non-slip material are placed. The strips 90 may be present in a multiplicity and varying patterns which are all intended to increase the stability of the present invention when it is placed on a surface. The strips 90 allow for secure placing of the present invention 10 on glass surfaces, granite countertops, and other surfaces which have a low coefficient of friction. The strips can be composed of silicone, rubber or similar material. Other embodiments can include that the entire surface of the bottom 42 of the base 40 is covered by the non-slip material 91.

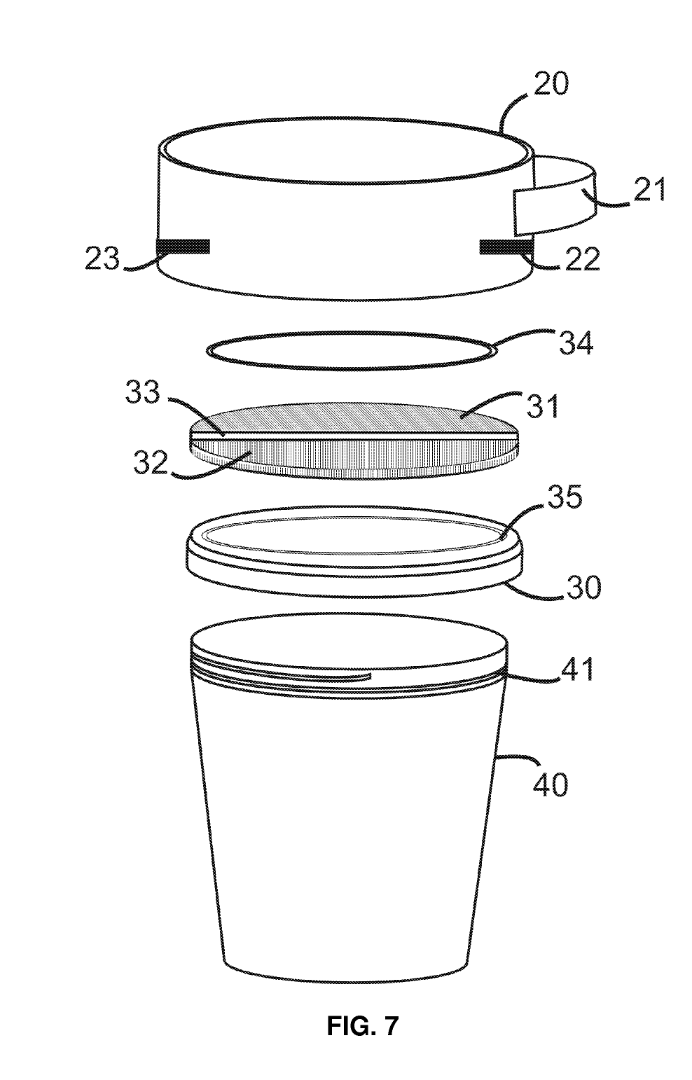

In FIG. 7, an embodiment which allows for replacement of the cover fabric 31-32 is shown. The first annular ring 30 is attached to the top 41 of the base 40. The cover fabric 31-32 is placed on top of the annular ring 30 and held in place by a washer 34 sized to fit on top of the first annular ring 30 by being pressed inside a gap 35 sized to receive the washer 34. In this embodiment, the second annular ring 20 is then placed on top of the washer 34 and contains a multiplicity of tabs or indentations 22-23. The indentations 22-23 aid to fasten the washer 34 in place over the cover fabric 31-32. This embodiment allows for easy replacement of the cover fabric 31-32 in a case where it is torn or damaged in some way. The easy removal of the fabric 31-32 also allows for it to be washed should a user wish to do so.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A food container assembly comprising:
a. a cylindrical shaped base for storing dry food objects having a bottom end being enclosed and a top end being open; said cylindrical shaped base having an interior and an exterior surfaces;
b. a first annular ring having a first end and a second end, wherein said first end being attached to said top end of said base by a coupling means and said second end being attached to a cover; said cover extending across said first end, wherein said cover comprising of two overlapping semicircular sections of a material, said cover being attached to said first annular ring by an attaching means;
c. a second annular ring being attached to said first annular ring having a wall, said wall having a height and a width;
d. a penannular shaped handle being extended from said wall; and
e. a motion sensor to detect a hand movement of a user inside of said base being attached at said interior surface of said base.

2. The food container assembly of claim 1, wherein said sensor being programmed to play a sound when detecting a motion.

3. The food container assembly of claim 1, wherein said first annular ring being replaceable.

4. The food container assembly of claim 1, wherein said material being selected from the groups consisting of a resilient fabric and a clear rubber.

5. The food container assembly of claim 1, wherein said bottom end of said base further having a plurality of strips, wherein said strips being made of non-slipping materials.

6. The food container assembly of claim 4, wherein said strips materials being selected from the groups consisting of a silicone, a rubber, and a plastic.

7. The food container assembly of claim 4, wherein said strips being sized to cover entirety of said bottom surface.
